(19) United States
(12) Patent Application Publication
(10) Pub. No.: US 2016/0036873 A1
(43) Pub. Date: Feb. 4, 2016

(54) CUSTOM INPUT ROUTING USING MESSAGING CHANNEL OF A UCC SYSTEM

(71) Applicant: SMART Technologies ULC, Calgary (CA)

(72) Inventors: Dietmar TONN, Calgary (CA); Heath WARD, Calgary (CA); David LIM, Calgary (CA); Patrick LEE, Calgary (CA); Adam PECK, Calgary (CA); Shuyu WANG, Calgary (CA); Doug DENNIE, Calgary (CA); Michael GREENLEE, Calgary (CA)

(21) Appl. No.: 14/814,922

(22) Filed: Jul. 31, 2015

Related U.S. Application Data
(60) Provisional application No. 62/032,190, filed on Aug. 1, 2014.

(51) Int. Cl. H04L 29/06; H04L 12/58

(52) U.S. Cl. CPC H04L 65/403; H04L 65/60; H04L 51/18; H04L 65/1069; H04L 51/046

(57) ABSTRACT

A collaboration and communication system comprises a host server and a plurality of participant computers. The host server is configured to execute a collaboration application; and a background message application configured to establish a background messaging session to facilitate communication of a representation of custom data not supported by the collaboration application. The plurality of participant computers are configured to execute: a client application configured to share data with the collaboration application in a collaboration session; a connector application configured to monitor the collaboration application client to determine when to communicate the custom data and communicate the custom data via the background messaging session. Methods for communicating custom data between the host server and the plurality of participant devices are also described.

The present invention relates generally to a unified communication and collaboration (UCC) system and specifically to a system and method for incorporating custom input, such as digital ink, into the UCC system using an existing messaging capability of the UCC. This application claims priority from U.S. Provisional Patent Application No. 62/032,190 filed on Aug. 1, 2014.

### BACKGROUND

Collaboration applications and environments allow session participants that may be remote from each other to interact online in a variety of ways or exchange a variety of communications. For instance, collaboration participants may engage in video exchanges, voice calls, instant messaging, white board presentations, and desktop views, or any combination or variation thereof. Microsoft® Lync® is an example application program suitable for providing such collaboration environments.

As the feasibility of collaborating online has increased, so too have the technologies with which collaboration environments can be delivered. For example, collaboration participants may engage in a video conference, voice call, instant messaging session or whiteboard presentations using devices such as traditional desktop or laptop computers, as well as tablets, mobile phones, gaming systems, dedicated collaboration systems, or any other suitable communication device.

The collaboration participants may also engage in the video conference, voice call, instant messaging session or white board presentations using interactive input systems that allow users to inject input, such as digital ink, mouse events and the like, into an application program or white board presentation. The user can inject the input using an active pointer, such as a pointer that emits light, sound, or other signal, a passive pointer, such as a finger, cylinder or other suitable object, or other suitable input devices such as a mouse or trackball, for example. These interactive input systems include but are not limited to: touch systems comprising touch panels employing analog resistive or machine vision technology to register pointer input such as those disclosed in U.S. Pat. Nos. 5.448,263; 6,141,000; 6,337,681; 6,747,636; 6,803,906; 7,232,986; 7,236,162; and 7,274,356 and in U.S. Patent Application Publication No. 2004/0179001, all assigned to SMART Technologies of ULC of Calgary, Alberta, Canada, assignee of the subject application, the entire disclosures of which are incorporated by reference; touch systems comprising touch panels employing electromagnetic, capacitive, acoustic or other technologies to register pointer input; tablet and laptop personal computers (PCs); smartphones; personal digital assistants (PDAs) and other handheld devices; and other similar devices.

However, if the features of the interactive input system are not native to, or supported by, the collaboration application, it may not be possible to share the input injected by a user with other users within the collaboration environment.

It is therefore an object to provide a novel system and method for sharing input injected into an interactive input system by a user with other users within the collaboration environment.

### SUMMARY OF THE INVENTION

In accordance with an aspect of an embodiment, there is provided a collaboration and a communication system comprising: a host server configured to execute: a collaboration application; and a background message application configured to establish a background messaging session to facilitate communication of a representation of custom data not supported by the collaboration application; a plurality of participant computers configured to execute: a client application configured to share data with the collaboration application in a collaboration session; a connector application configured to: monitor the collaboration application client to determine when to communicate the custom data; and communicate the custom data via the background messaging session.

In accordance with another aspect of an embodiment, there is provided a method for establishing a background communication channel between a host server and a participant device, the method comprising: receiving a request at the host server to establish the background communication channel, the request including a conference identifier for an existing collaboration session; creating a background conference to facilitate the background communication channel, the background conference comprising a background conference identifier; associating the background conference identifier with the conference identifier; and communicating the background conference identifier to the participant device.

In accordance with yet another aspect of an embodiment, there is provided a method for communicating custom data between a host server and a plurality of participant devices using a background communication channel, the method comprising: transmitting a request to the host server to establish the background communication channel, the request including a conference identifier for an existing collaboration session; receiving a background conference identifier from the host device; and using the background communication channel to transmit or receive the custom data with one of more of the plurality of participants.

### BRIEF DESCRIPTION OF THE DRAWINGS

Embodiments of the Invention will now be described by way of example only with reference to the accompanying drawings in which:

FIG. 1 is a diagram of an interactive input system;

FIG. 2 is block diagram of a collaborative environment;

FIG. 3 is a block diagram of a participant device;

FIG. 4 is a flow chart illustrating transmitting custom data from a viewer;

FIG. 5 is a flow chart illustrating receiving custom data at a presenter; and

FIG. 6 is a flow chart illustrating establishing a background communication channel used to communicate custom data.

### DETAILED DESCRIPTION OF THE EMBODIMENTS

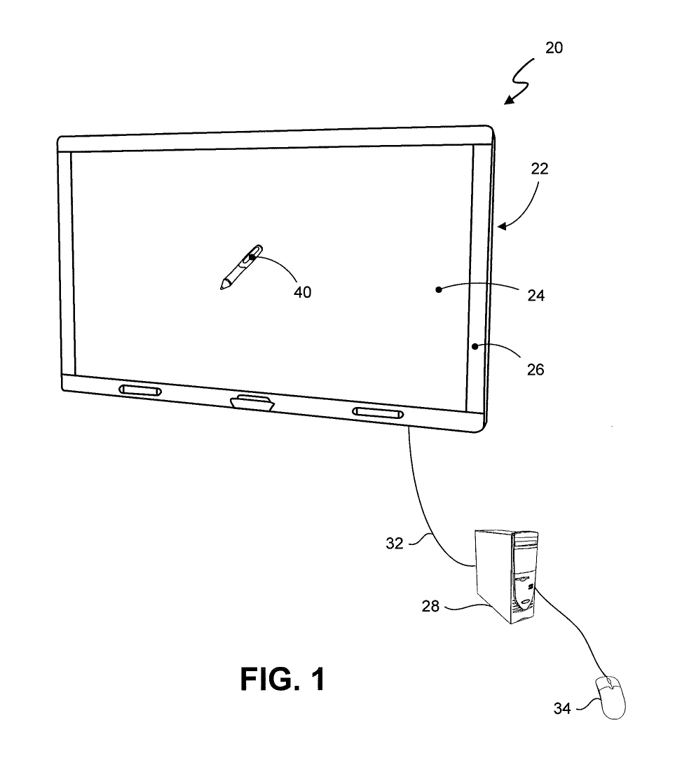

For convenience, like numerals in the description refer to like structures in the drawings. Referring to FIG. 1, an interactive input system that allows a user to inject custom input such as digital ink, mouse events and the like into an executing application program is shown and is generally identified by reference numeral 20. In this embodiment, interactive input system 20 comprises an interactive board 22 mounted on a vertical support surface such as for example, a wall surface or the like or otherwise suspended or supported in an upright orientation. Interactive board 22 comprises a generally planar, rectangular interactive surface 24 that is surrounded about its periphery by a bezel 26. An image, such as for example a computer desktop is displayed on the interactive surface 24. In this embodiment, a liquid crystal display (LCD) panel or other suitable display device displays the image, the display surface of which defines interactive surface 24.

The interactive board 22 employs machine vision to detect one or more pointers brought into a region of interest in proximity with the interactive surface 24. The interactive board 22 communicates with a general purpose computing device 28 executing one or more application programs via a universal serial bus (USB) cable 32 or other suitable wired or wireless communication link. One of the application programs is an interactive input application that is configured to process the output of the interactive board 22 and adjust image data that is output to the interactive board 22, if required, so that the image presented on the interactive surface 24 reflects pointer activity. In this manner, the interactive board 22 and the interactive input application allow pointer activity proximate to the interactive surface 24 to be recorded as custom input, such as digital ink used in writing or drawing, or used to control execution of one or more application programs executed by the general purpose computing device 28. Further, the interactive input application can provide a text representation of the recorded input. In an embodiment, the custom input, such as digital ink, can be represented using extensible markup language (XML). Accordingly, interactive input application creates an XML representation of the digital ink.

Imaging assemblies (not shown) are accommodated by the bezel 26, with each imaging assembly being positioned adjacent a different corner of the bezel. Each imaging assembly comprises an image sensor and associated lens assembly that provides the image sensor with a field of view sufficiently large as to encompass the entire interactive surface 24. A digital signal processor (DSP) or other suitable processing device sends clock signals to the image sensor causing the image sensor to capture image frames at the desired frame rate. The imaging assemblies are oriented so that their fields of view overlap and look generally across the entire interactive surface 24. In this manner, any pointer such as for example a user's finger, a cylinder or other suitable object, a pen tool 40 or an eraser tool that is brought into proximity of the interactive surface 24 appears in the fields of view of the imaging assemblies and thus, is captured in image frames acquired by multiple imaging assemblies.

When the imaging assemblies acquire image frames in which a pointer exists, the imaging assemblies convey the image frames to a master controller. The master controller in turn processes the image frames to determine the position of the pointer in (x,y) coordinates relative to the interactive surface 24 using triangulation. The pointer coordinates are then conveyed to the general purpose computing device 28 which uses the pointer coordinates to update the image displayed on the interactive surface 24 if appropriate. Pointer contacts on the interactive surface 24 can therefore be recorded as writing or drawing or used to control execution of application programs running on the general purpose computing device 28.

The general purpose computing device 28 in this embodiment is a personal computer or other suitable processing device comprising, for example, a processing unit, system memory (volatile and/or non-volatile memory), other non-removable or removable memory (e.g., a hard disk drive, RAM, ROM, EEPROM, CD-ROM, DVD, flash memory, etc.) and a system bus coupling the various computing device components to the processing unit. The general purpose computing device 28 may also comprise networking capability using Ethernet, WiFi, and/or other network format, for connection to access shared or remote drives, one or more networked computers, or other networked devices.

The interactive input system 20 is able to detect passive pointers such as for example, a user's finger, a cylinder or other suitable objects as well as passive and active pen tools 40 that are brought into proximity with the interactive surface 24 and within the fields of view of imaging assemblies. The user may also enter input or give commands through a mouse 34 or a keyboard (not shown) connected to the general purpose computing device 28. Other input techniques such as voice or gesture-based commands may also be used for user interaction with the interactive input system 20.

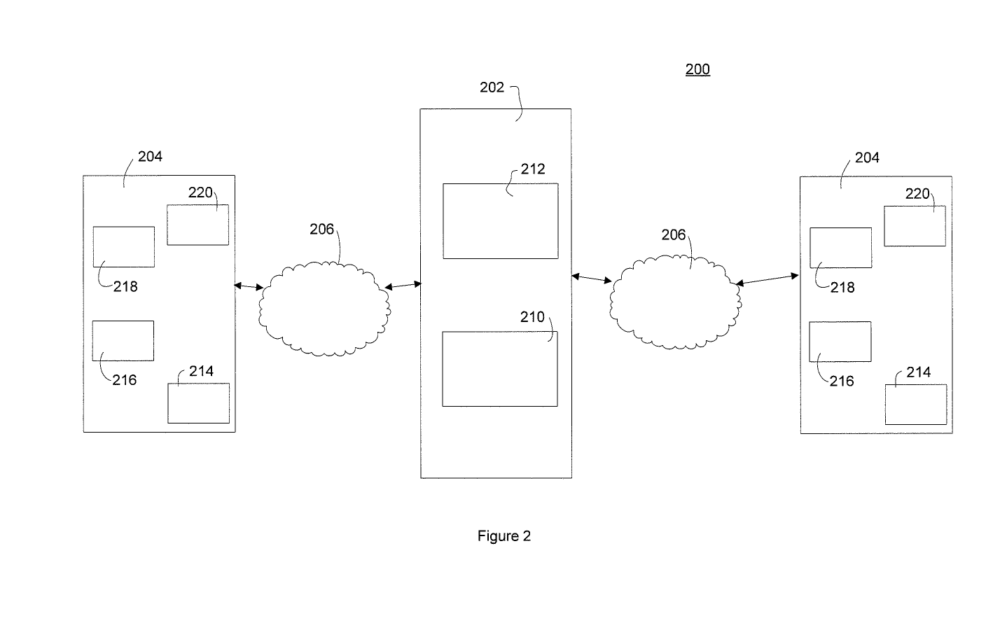

Referring to FIG. 2, a collaboration environment is illustrated generally by numeral 200. The collaboration environment 200 comprises a host server 202, a plurality of participant devices 204 and communication network 206. The participant devices 204 communicate with the host server 202 via the communication network.

The communication network 206 includes local area networks, such an intranets, and wide area networks, such as the Internet, as will be appreciated by a person skilled in the art. The participant devices 204 and the host server 202 may be connected to the communication network 206 via a wired or wireless connection.

The host server 202 comprises one or more personal computers, network computers or other suitable processing devices. The one or more computers comprising the host server 202 may be co-located at a common site, or distributed across multiple sites. The host server 202 is configured to run a collaboration application 210. In an exemplary embodiment, the collaboration application 210 is Microsoft® Lync® Server. The host server 202 is further configured to execute a background message application 212. The collaboration application 210 and the background message application 212 may be co-located at a common site or at different sites. The host server 202 further includes additional modules such as an instant message multipoint control unit (MCU) that will be described later.

The participant devices 204 may include traditional desktop or laptop computers, as well as tablets, mobile phones, gaming systems, dedicated collaboration systems, the general purpose computing device 28 of the interactive input system 20 or any other suitable computing device. Each of the participant devices 204 is configured to run a client application 214. The client application 214 connects the participant device 204 to the collaboration application 210 at the host server 202. In an embodiment, the client application 214 is a Microsoft® Lync® client application.

Further, in order to facilitate interaction with third party applications, such as the interactive input application executed by the general purpose computing device 28, the participant devices 204 are configured to run a connector application 216. Yet further, in order to facilitate sharing of user input received by the interactive input application, the participant devices are configured to run a background proxy service 218 and a background collaboration application client 220. Although illustrated separately, the connector application 216 and the background proxy service 218 may be combined in a single application. The connector application 216, the background proxy service 218, and the background collaboration application client 220 may be transparent to participants using the participant devices 204.

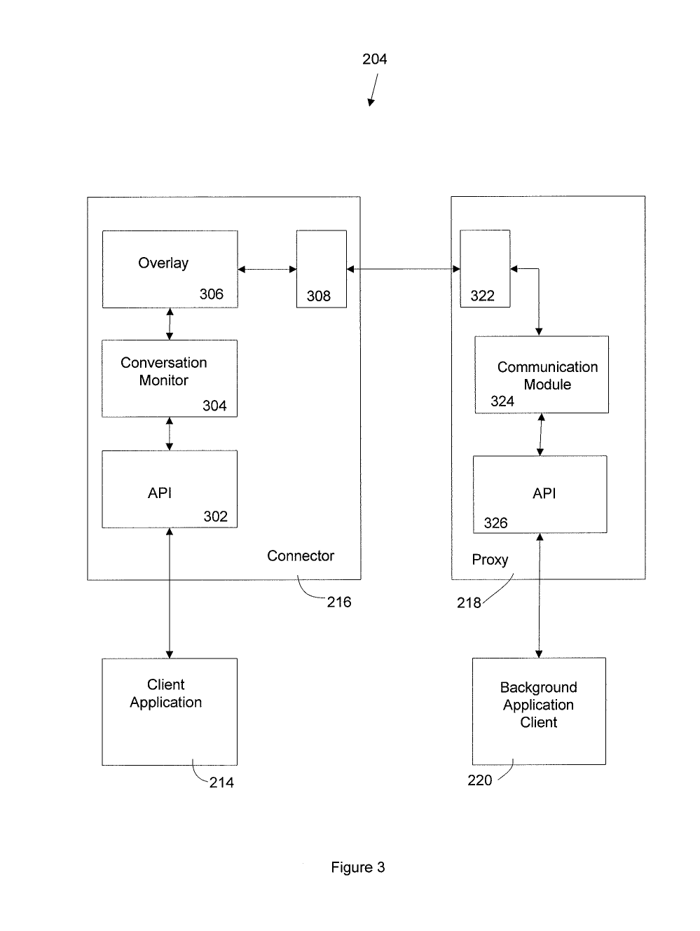

Referring to FIG. 3, the participant device 204 is illustrated in greater detail. As shown in FIG. 3, the connector application 216 comprises a connector application program interface (API) 302, a conversation monitor 304, an ink overlay 306 and a local client 308. The background proxy service 218 comprises a local service 322, and ink communication module 324 and a proxy API 326.

The connector application 216 is configured to communicate with the client application 214 via the connector API 302. In an embodiment, the connector API is a Microsoft® Lync® API, which is defined in a software development kit (SDK) provided by Microsoft®. The conversation monitor 304 is configured to monitor events at the client application 214 in order to detect a sharing event. A sharing event is a predefined event identifying that the client application 214 is to be used for sharing information with a plurality of participants. An example of a sharing event is a presentation event, which identifies that collaboration environment 200 is to be used for a presentation among the participants. For a presentation, one participant is usually considered to be a presenter and the remaining participants are considered to be viewers.

The ink overlay 306 is configured to receive a representation of the digital ink from the general purpose computing device 28. As previously described the digital ink is represented in text form, particularly in an XML document.

The local client 308 is configured to communicate data between the ink overlay 306 and the local service 322. In an embodiment, the local client 308 is a Windows Communication Foundation (WCF) client and the local service 322 is a WCF service. Alternatively, if the connector application 216 and the background proxy service 218 are implemented as a single application, then a separate local client such as local client 308 and a separate local service such as local service 322 may not be necessary. The local service 322 is configured to communicate data between the local client 308 and the ink communication module 324.

The ink communication module 324 is configured to prepare the text representation of the digital ink for transmission. The text representation of the digital ink is prepared for transmission based on the type of messaging available through the background collaboration application 220. In an embodiment, the text representation of the digital ink is prepared for transmission using instant messaging. The ink communication module 324 is configured to communicate with the background client application 220 via the proxy API 326. In an embodiment, the proxy API is a Microsoft® Lync® API.

One or more participants can join a collaboration session by connecting their respective participant devices 204 to the host server 202 via the client application 210. The collaboration session is identified by a conference identifier. Participants of the collaboration session can all be co-located at a common site, or can alternatively be located at different sites. It will be understood that the computing devices may run any operating system such as Microsoft Windows™, Apple iOS, Apple OS X, Linux, Android and the like. The client applications 210 running on the participant devices 204 provide an interface to the host server 202, regardless of the operating system. The collaboration application 210 communicates with each participant device joined to the collaboration session, and shares content of the collaboration session therewith.

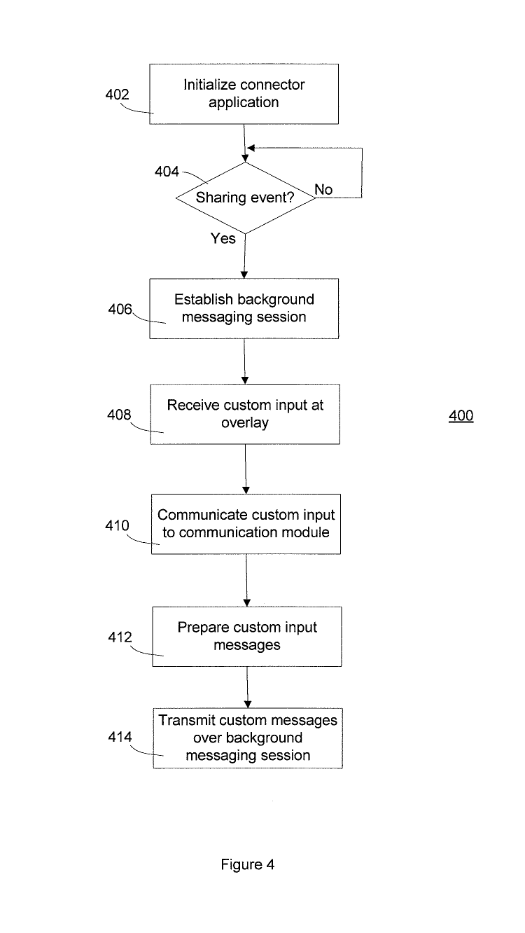

During a presentation, data is presented from a presenter to a plurality of viewers. Referring to FIG. 4, a flow chart illustrating how the digital ink data is communicated from one or more of the viewers to the presenter is illustrated generally by numeral 400. At 402, the connector application 216 is initialized. Depending on the implementation, the connector application 216 may be initialized in response to a user request, such as by selecting a button within an application, or automatically upon execution of an application, such as the client application 214. During initialization of the connector application 216, the background proxy service 218 and the background collaboration application client 220 are activated.

At 404, the conversation monitor 304 monitors the client application 214 for a sharing event, which in this embodiment is a presentation. At 406, when the presentation is detected, the ink communication module 324 establishes a background messaging session with all of the participant devices 204 using the background collaboration application client 220. At 408, the representation of digital ink is received at the ink overlay 306. At 410, the representation of digital ink is communicated to the ink communication module 324. At 412, the ink communication module 324 prepares one or more digital ink messages to include the representation of the digital ink. At 414 the digital ink messages are communicated to the presenter's participant device 204 using the background messaging session.

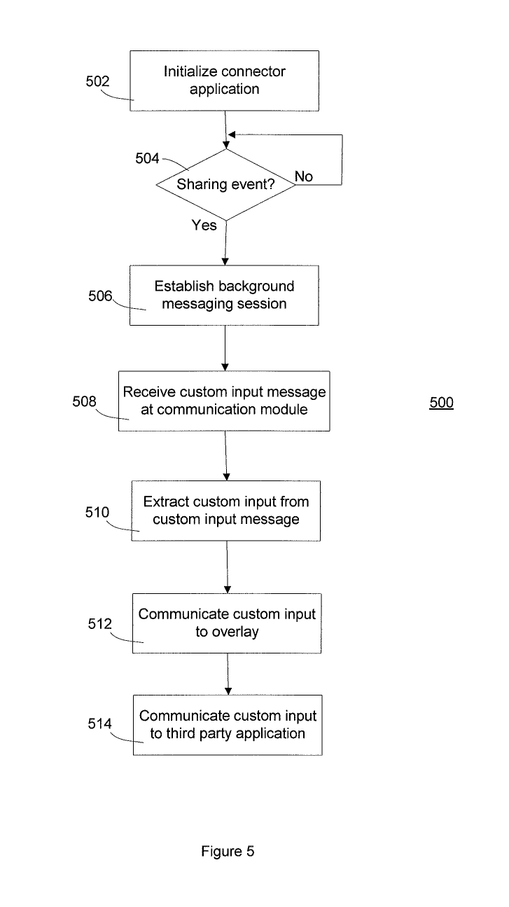

Referring to FIG. 5, a flow chart illustrating how the digital ink data from one or more of the viewers is received by the presenter is illustrated generally identified by numeral 500. At 502, the connector application 216 is initialized. Depending on the implementation, the connector application 216 may be initialized in response to a user request, such as by selecting a button within an application, or automatically upon execution of an application, such as the client application 214. During initialization of the connector application 216, the background proxy service 218 and the background collaboration application client 220 are activated.

At 504, the conversation monitor 304 monitors the client application 214 for a sharing event, which in this embodiment is a presentation. At 506, when the presentation is detected, the ink communication module 324 establishes a background messaging session with all of the participant devices 204 using the background collaboration application client 220. At 508, the digital ink messages are received at the ink communication module 324 using the background messaging session. At 510, the representation of the digital ink is extracted from the digital messages. At 512, the representation of digital ink is communicated from the ink communication module 324 to the ink overlay 306. At 514, the representation of digital ink is communicated from the ink overlay 306 to the interactive input application for injecting into the presentation.

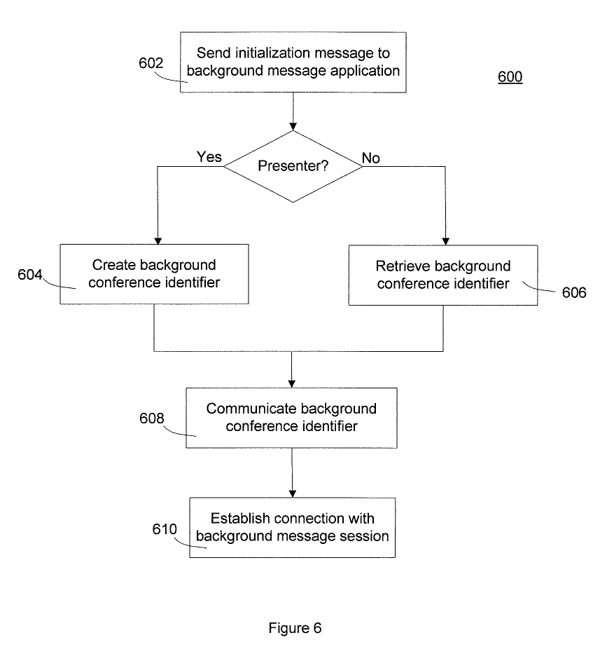

Referring to FIG. 6, a flow chart illustrating establishing the background messaging session 406 and 506 is shown. At 602, the ink communication module 324 sends an initialization message to the background message application 212. The initialization message includes a user-type identifier that identifies whether the participant device 204 is being used by the presenter or one of the viewers. The initialization message includes the conference identifier.

If the user-type identifier identifies that the participant device 204 is being used by the presenter, then at 604 the background message application 212 creates a background conference at the collaboration application 210. The background conference includes a background conference identifier and an instant message multipoint control unit (MCU). A reference table is established associating the background session identifier with the background conference identifier. In an embodiment, the background conference identifier is the conference identifier appended by a predefined suffix. For example, for a conference identifier N, the background conference identifier could be NINK, where the predefined suffix is INK.

If the user-type identifier identifies that the participant device 204 is being used by one of the viewers, then at 606 the background message application 212 correlates the background session identifier with the background conference identifier using the reference table.

At 608, the background conference identifier is communicated to the background collaboration application client 220. At 610, the background collaboration application client 220 establishes a connection to the background messaging session, which is used to communicate the digital ink messages.

In the embodiment described above, digital ink messages communicated via the background messaging session are communicated to all participant devices 204 taking part therein. Accordingly, the digital ink messages are ignored by the ink communication module 324 for participant devices 204 that are identified as viewers. Only the presenter participant device extracts the received digital ink and overlays it onto the presentation. In an alternative embodiment, the background message application 212 may be configured to route the digital ink messages so that they are only communicated to the participant device 204 that is identified as the presenter.

Yet further, in the embodiment described above, the background messaging session is used to communicate digital ink messages representing digital ink input into the interactive input system 20. In alternative embodiments, the background messaging session may be used to transmit other custom data, as long as it can be represented in a format that can be communicated using the messaging channel. For example, in addition to digital ink annotations and digital ink erasures the custom data may include short audio messages such as beeps, alarm indicators of danger or the presence of specific individuals or situations at the location of the participant sending the message and the like.

Yet further, in the embodiment described above, the participant device 204 comprises both the client application 214 and the background collaboration application client 220. Both clients are provided as a result of limitations in the API. In an alternative embodiment, the client application 214 may be configured to provide the functionality of the background collaboration application client 220.

Yet further, in the embodiment described above, both the client application 214 and the background collaboration application client 220 are native applications. In an alternative embodiment, the client application 214 and the background collaboration application client 220 may be implemented as web-based applications or a mix of web-based and native applications.

Although in embodiments described above the interactive input system is described as utilizing an LCD device for displaying the images, those skilled in the art will appreciate that other types of interactive input systems may be used. For example, an interactive input system that includes a boom assembly to support a short-throw projector such as that sold by SMART Technologies ULC under the name “SMART UX60”, which projects an image, such as for example, a computer desktop, onto the interactive surface 24 may be employed.

Further, although in embodiments described above the interactive input system is described as detecting user input using imaging assemblies, those skilled in the art will appreciate that other types of interactive input systems may be used. For example, interactive input systems that include other types of touch screen technology, such as capacitive, resistive, acoustic and the like may be employed.

Although embodiments have been described above with reference to the accompanying drawings, those of skill in the art will appreciate that variations and modifications may be made without departing from the scope thereof as defined by the appended claims.

What is claimed is:

1. A collaboration and communication system comprising:
a host server configured to execute:
a collaboration application; and
a background message application configured to establish a background messaging session to facilitate communication of a representation of custom data not supported by the collaboration application;
a plurality of participant computers configured to execute:
a client application configured to share data with the collaboration application in a collaboration session;
a connector application configured to:
monitor the collaboration application client to determine when to communicate the custom data; and
communicate the custom data via the background messaging session.

2. A method for establishing a background communication channel between a host server and a participant device, the method comprising:
receiving a request at the host server to establish the background communication channel, the request including a conference identifier for an existing collaboration session;
creating a background conference to facilitate the background communication channel, the background conference comprising a background conference identifier;
associating the background conference identifier with the conference identifier; and
communicating the background conference identifier to the participant device .

3. The method of claim 2, further comprising:
receiving subsequent requests from other participant devices including the conference identifier;
determining the background conference identifier based on the conference identifier; and
communicating the background conference identifier to the other participant device.

4. The method of claim 2, wherein the custom data is received in text format representing the custom data.

5. The method of claim 2, wherein the custom data is digital ink.

6. A method for communicating custom data between a host server and a plurality of participant devices using a background communication channel, the method comprising:
transmitting a request to the host server to establish the background communication channel, the request including a conference identifier for an existing collaboration session;
receiving a background conference identifier from the host device; and
using the background communication channel to transmit or receive the custom data with one of more of the plurality of participants.

7. The method of claim 6, further comprising:
receiving the custom data from a third party application;
preparing at least one custom data message representing the custom data; and
communicating the at least one custom data message using the background communication channel.

8. The method of claim 6, wherein the request includes a user-type identifier identifying whether the participant device is a presenter or a viewer.

9. The method of any claims 8, wherein the at least one custom data message is communicated to all of the plurality of participant devices.

10. The method of claim 9, wherein the at least one custom data message is ignored by all participant devices that are viewers.

11. The method of claim 8, wherein the at least one custom data message is only communicated to participants devices that are presenters.

12. The method of claim 6, further comprising:
receiving at least one custom data message representing the custom data;
extracting the custom data from the at least one custom data message; and
communicating the custom data to a third party application for processing.

13. The method of claim 6, wherein the custom data is received in text format representing the custom data.

12. The method of claim 6, wherein the custom data is digital ink.
